(19) United States
(12) Patent Application Publication
(10) Pub. No.: US 2026/0135311 A1
(43) Pub. Date: May 14, 2026

(54) CONNECTOR ASSEMBLY

(71) Applicant: I-PEX Inc., Kyoto-shi (JP)

(72) Inventors: Hiroshi WADA, Fukuoka (JP); Ryosuke TAKEI, Fukuoka (JP); Hirotake KANEKO, Fukuoka (JP)

(21) Appl. No.: 19/443,019

(22) Filed: Jan. 8, 2026

Related U.S. Application Data
(63) Continuation of application No. PCT/JP2024/019938, filed on May 30, 2024.

(30) Foreign Application Priority Data
Jul. 12, 2023 (JP) 2023-114667

(51) Int. Cl. H01R 12/77

(52) U.S. Cl. CPC H01R 12/775; H01R 12/777

(57) ABSTRACT

A connector assembly includes a connector and an other-end connector, each having pairs of first and second contacts arranged along an arrangement orientation. A wiring member connecting the connectors includes pairs of straight lines and pairs of cross lines alternately arranged along the arrangement orientation. Each pair of straight lines connects the first and second contacts of the connector to the first and second contacts of the other-end connector, respectively. Each pair of cross lines connects the first contact of the connector to the second contact of the other-end connector, and the second contact of the connector to the first contact of the other-end connector.

### CROSS-REFERENCE TO RELATED APPLICATIONS

This application is a continuation application of PCT Application No. PCT/JP 2024/019938, filed on May 30, 2024, which claims the benefit of priority from Japanese Patent Application No. 2023-114667, filed on Jul. 12, 2023. The entire contents of the above listed PCT and priority applications are incorporated herein by reference.

### BACKGROUND

### Field

The present disclosure relates to a connector assembly.

### Description of the Related Art

Japanese Unexamined Patent Publication No. 2001-184954 discloses a configuration in which there are two or more twisted-pair insulated wires formed by twisting two insulated wires together, terminals attached to respective ends of the insulated wires of the plurality of sets are connected to the same connector, and the plurality of sets of twisted-pair insulated wires are laid in parallel; the configuration further discloses that twist pitches of the twisted-pair insulated wires of the plurality of sets are the same, and, in a state where the terminals are connected to the connector and are laid in parallel, phases of at least two sets of twisted-pair insulated wires arranged adjacently in parallel are shifted such that a valley portion of one twisted-pair insulated wire is located at a position of a peak portion of the other twisted-pair insulated wire.

### SUMMARY

Disclosed herein is a connector assembly. The connector assembly may include: a connector including a plurality of pairs of conductive contacts arranged along an arrangement orientation; an other-end connector including a plurality of pairs of conductive other-end contacts arranged along the arrangement orientation; and a wiring member extending from the connector toward the other-end connector and connecting the plurality of pairs of contacts and the plurality of pairs of other-end contacts, respectively. Each of the plurality of pairs of contacts may include a first contact and a second contact arranged from one side to another side in the arrangement orientation. Each of the plurality of pairs of other-end contacts may include a first other-end contact and a second other-end contact arranged from the one side to the other side in the arrangement orientation. The wiring member may include: a plurality of pairs of straight lines, each pair including a first straight line connecting the first contact and the first other-end contact, and a second straight line connecting the second contact and the second other-end contact; and a plurality of pairs of cross lines, each pair including a first cross line connecting the first contact and the second other-end contact, and a second cross line connecting the second contact and the first other-end contact. The plurality of pairs of straight lines and the plurality of pairs of cross lines may be alternately arranged along the arrangement orientation.

Additionally, a connector assembly is disclosed herein. The connector assembly may include: a connector including a plurality of pairs of conductive contacts arranged along an arrangement orientation; an other-end connector including a plurality of pairs of conductive other-end contacts arranged along the arrangement orientation; and a wiring member extending from the connector toward the other-end connector and connecting the plurality of pairs of contacts and the plurality of pairs of other-end contacts, respectively. The wiring member may include: a plurality of pairs of straight lines; and a plurality of pairs of cross lines, which are alternately arranged along the arrangement orientation. The wiring member may further include: a plurality of pairs of straight ground lines, each pair including a first straight ground line and a second straight ground line connected to the connector so as to be connected to a ground and connected to the other-end connector so as to be connected to an other-end ground, in which the first straight ground line and the second straight ground line are arranged from the one side to the other side in the arrangement orientation at the connector and are arranged from the one side to the other side in the arrangement orientation at the other-end connector; and a plurality of pairs of cross ground lines, each pair including a first cross ground line and a second cross ground line connected to the connector so as to be connected to the ground and connected to the other-end connector so as to be connected to the other-end ground, in which the first cross ground line and the second cross ground line are arranged from the one side to the other side in the arrangement orientation at the connector and are arranged from the other side to the one side in the arrangement orientation at the other-end connector. The plurality of pairs of straight ground lines and the plurality of pairs of cross ground lines may be alternately arranged along the arrangement orientation.

Additionally, a connector assembly is disclosed herein. The connector assembly may include: a connector including a conductive first contact and a conductive second contact arranged from one side to another side in an arrangement orientation, and a conductive second-layer first contact and a conductive second-layer second contact arranged along a row parallel to a row in which the first contact and the second contact are arranged, so as to respectively correspond to the first contact and the second contact; an other-end connector including a conductive first other-end contact and a conductive second other-end contact arranged from the one side to the other side in the arrangement orientation, and a conductive second-layer first other-end contact and a conductive second-layer second other-end contact arranged along a row parallel to a row in which the first other-end contact and the second other-end contact are arranged, so as to respectively correspond to the first other-end contact and the second other-end contact; and a wiring member including a first straight line extending from the connector to the other-end connector and connecting the first contact and the first other-end contact, a second straight line extending from the connector to the other-end connector and connecting the second contact and the second other-end contact, a second-layer first cross line extending from the connector to the other-end connector and connecting the second-layer first contact and the second-layer second other-end contact, and a second-layer second cross line extending from the connector to the other-end connector and connecting the second-layer second contact and the second-layer first other-end contact.

### BRIEF DESCRIPTION OF THE DRAWINGS

FIG. 1 is a schematic diagram (plan view) illustrating a connector assembly.

FIG. 2 is an enlarged view (perspective view) of fingers.

FIG. 3 is a schematic diagram (plan view) illustrating a modified example of the connector assembly.

FIG. 4 is a schematic diagram (plan view) illustrating another modified example of the connector assembly.

FIG. 5 is a schematic diagram (plan view) illustrating yet another modified example of the connector assembly.

FIG. 6 is a schematic diagram (side view) illustrating yet another modified example of the connector assembly.

FIG. 7 is a schematic diagram (plan view) illustrating yet another modified example of the connector assembly.

### DETAILED DESCRIPTION

In the following description, with reference to the drawings, the same reference numbers are assigned to the same components or to similar components having the same function, and overlapping description is omitted.

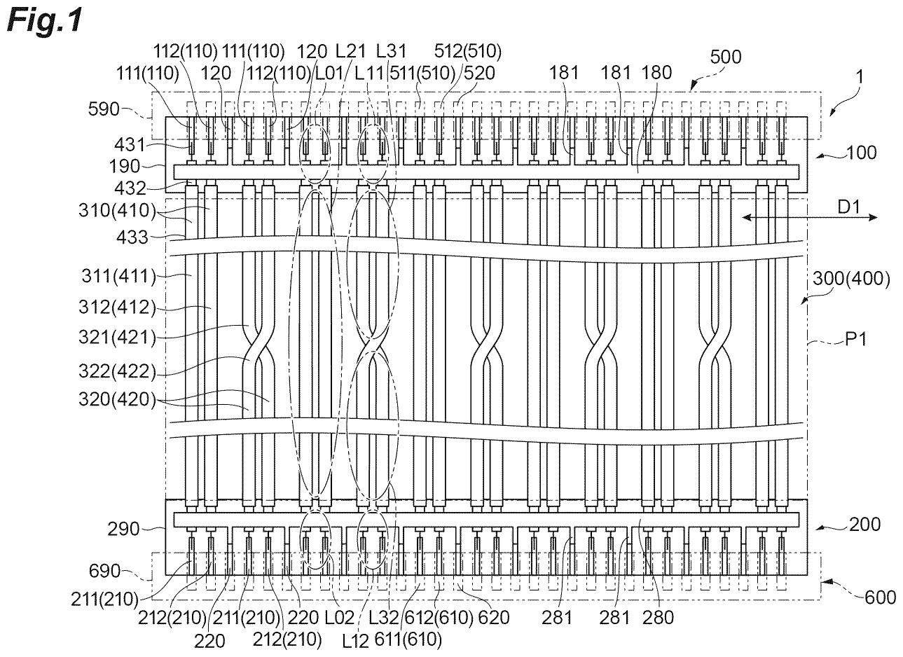

As illustrated in FIG. 1, a connector assembly 1 includes a connector 100 that is connectable to a mate connector 500, an other-end connector 200 that is connectable to an other-end mate connector 600, and a wiring member 300 that electrically connects the connector 100 and the other-end connector 200, wherein the connector assembly 1 electrically connects the mate connector 500 and the other-end mate connector 600. For example, the mate connector 500 and the other-end mate connector 600 may be provided on the same circuit board. The connector assembly 1 performs signal transmission between the mate connector 500 and the other-end mate connector 600 instead of, for example, printed wiring that could be provided on the circuit board. With the connector assembly 1 formed separately from the circuit board, noise countermeasures can be applied to the wiring member 300 without being constrained by layout on the circuit board, and signals can be transmitted with improved signal transmission characteristics than printed wiring on the circuit board.

As illustrated in FIG. 1, the mate connector 500 includes a plurality of pairs of mate contacts 510 and a mate housing 590. The plurality of pairs of mate contacts 510 are arranged along an arrangement orientation D1. Each of the plurality of pairs of mate contacts 510 includes a first mate contact 511 and a second mate contact 512 arranged from one side (for example, the left side in the figure) to the other side (for example, the right side in the figure) in the arrangement orientation D1. The “one side” of the arrangement orientation D1 may be the left side or the right side in FIG. 1; when the “one side” of the arrangement orientation D1 is used at multiple locations in the description of the connector assembly 1, these refer to the same side. The same applies to the “other side” of the arrangement orientation D1. Each of the first mate contact 511 and the second mate contact 512 is formed of, for example, a metal material such as copper and is conductive. The mate housing 590 is insulative and holds the plurality of pairs of mate contacts 510 so that they are insulated from each other.

As illustrated in FIG. 1, the other-end mate connector 600 includes a plurality of pairs of other-end mate contacts 610 and an other-end mate housing 690. The plurality of pairs of other-end mate contacts 610 are arranged along the arrangement orientation D1. Each of the plurality of pairs of other-end mate contacts 610 includes a first other-end mate contact 611 and a second other-end mate contact 612 arranged from the one side to the other side in the arrangement orientation D1. Each of the first other-end mate contact 611 and the second other-end mate contact 612 is formed of, for example, a metal material such as copper and is conductive. The other-end mate housing 690 is insulative and holds the plurality of pairs of other-end mate contacts 610 so that they are insulated from each other.

As illustrated in FIG. 1, the connector 100 includes a plurality of pairs of contacts 110 and a housing 190. The plurality of pairs of contacts 110 are arranged along the arrangement orientation D1. Each of the plurality of pairs of contacts 110 includes a first contact 111 and a second contact 112 arranged from one side to the other side in the arrangement orientation D1. Each of the first contact 111 and the second contact 112 is formed of, for example, a metal material such as copper and is conductive.

The housing 190 is insulative and holds the plurality of pairs of contacts 110 so that they are insulated from each other. The housing 190 mates with the mate housing 590 of the mate connector 500. When the housing 190 mates with the mate housing 590, the plurality of pairs of contacts 110 respectively contact the plurality of pairs of mate contacts 510. For example, the first contact 111 contacts the first mate contact 511, and the second contact 112 contacts the second mate contact 512.

As illustrated in FIG. 1, the other-end connector 200 includes a plurality of pairs of other-end contacts 210 and an other-end housing 290. The plurality of pairs of other-end contacts 210 are arranged along the arrangement orientation D1. Each of the plurality of pairs of other-end contacts 210 includes a first other-end contact 211 and a second other-end contact 212 arranged from one side to the other side in the arrangement orientation D1. Each of the first other-end contact 211 and the second other-end contact 212 is formed of, for example, a metal material such as copper and is conductive.

The other-end housing 290 is insulative and holds the plurality of pairs of other-end contacts 210 so that they are insulated from each other. The other-end housing 290 mates with the other-end mate housing 690 of the other-end mate connector 600. When the other-end housing 290 mates with the other-end mate housing 690, the plurality of pairs of other-end contacts 210 respectively contact the plurality of pairs of other-end mate contacts 610. For example, the first other-end contact 211 contacts the first other-end mate contact 611, and the second other-end contact 212 contacts the second other-end mate contact 612.

As illustrated in FIG. 1, the wiring member 300 extends from the connector 100 toward the other-end connector 200 and respectively connects the plurality of pairs of contacts 110 and the plurality of pairs of other-end contacts 210. As a noise countermeasure as described above, the wiring member 300 includes a plurality of pairs of straight lines 310, each pair including a first straight line 311 that connects the first contact 111 and the first other-end contact 211 and a second straight line 312 that connects the second contact 112 and the second other-end contact 212. Further, the wiring member 300 includes a plurality of pairs of cross lines 320, each pair including a first cross line 321 that connects the first contact 111 and the second other-end contact 212 and a second cross line 322 that connects the second contact 112 and the first other-end contact 211. The plurality of pairs of straight lines 310 and the plurality of pairs of cross lines 320 are alternately arranged along the arrangement orientation D1. The plurality of pairs of straight lines 310 and the plurality of pairs of cross lines 320 extend along the arrangement orientation D1 and are arranged along a plane extending from the connector 100 toward the other-end connector 200. Hereinafter, this plane is referred to as a “connection plane P1”.

With the configuration in which the plurality of pairs of straight lines 310 and the plurality of pairs of cross lines 320 are alternately arranged along the arrangement orientation D1, a noise current induced in the plurality of pairs of cross lines 320 by a magnetic field from the plurality of pairs of straight lines 310 in the connector 100 and a noise current induced in the plurality of pairs of cross lines 320 by a magnetic field from the plurality of pairs of straight lines 310 in the other-end connector 200 are opposite in direction to each other and cancel each other. Similarly, a noise current induced in the plurality of pairs of straight lines 310 by a magnetic field from the plurality of pairs of cross lines 320 in the connector 100 and a noise current induced in the plurality of pairs of straight lines 310 by a magnetic field from the plurality of pairs of cross lines 320 in the other-end connector 200 are opposite in direction to each other and cancel each other. Therefore, crosstalk is suppressed.

For example, each of the plurality of pairs of straight lines 310 forms, inside the connector 100, a portion L01 in which the first straight line 311 and the second straight line 312 are arranged from one side to the other side in the arrangement orientation D1, and also forms, inside the other-end connector 200, a portion L02 in which the first straight line 311 and the second straight line 312 are arranged from one side to the other side in the arrangement orientation D1. Each of the plurality of pairs of cross lines 320 forms, inside the connector 100, a portion L11 in which the first cross line 321 and the second cross line 322 are arranged from one side to the other side in the arrangement orientation D1, and forms, inside the other-end connector 200, a portion L12 in which the first cross line 321 and the second cross line 322 are arranged from the other side to the one side in the arrangement orientation D1. The portions L01 and L02 generate magnetic fields in the same direction (the same direction in a direction intersecting the connection plane P1) by current flowing from the first straight line 311 to the second straight line 312. In the portion L11, the first cross line 321 and the second cross line 322 are arranged from one side to the other side in the arrangement orientation D1, and in the portion L12, the first cross line 321 and the second cross line 322 are arranged from the other side to the one side in the arrangement orientation D1. Therefore, a noise current induced in the first cross line 321 and the second cross line 322 by a magnetic field acting from the portion L01 on the portion L11 and a noise current induced in the first cross line 321 and the second cross line 322 by a magnetic field acting from the portion L02 on the portion L12 are opposite in direction to each other and cancel each other. The portions L11 and L12 generate magnetic fields opposite in direction (opposite directions in a direction intersecting the connection plane P1) by current flowing from the first cross line 321 to the second cross line 322. Since in each of the portions L01 and L02, the first straight line 311 and the second straight line 312 are arranged from one side to the other side in the arrangement orientation D1, a noise current induced in the first straight line 311 and the second straight line 312 by a magnetic field acting from the portion L11 on the portion L01 and a noise current induced in the first straight line 311 and the second straight line 312 by a magnetic field acting from the portion L12 on the portion L02 are opposite in direction to each other and cancel each other. Therefore, crosstalk is suppressed.

As an example of the plurality of pairs of straight lines 310 and the plurality of pairs of cross lines 320, the first straight line 311 and the second straight line 312 do not intersect each other when viewed from a direction intersecting the connection plane P1, and the first cross line 321 and the second cross line 322 intersect each other at one location. A position where the first cross line 321 and the second cross line 322 intersect is located near the midpoint between the connector 100 and the other-end connector 200.

Since the first straight line 311 and the second straight line 312 do not intersect each other, each of the plurality of pairs of straight lines 310 includes, over the entire length from the connector 100 to the other-end connector 200, a portion L21 in which the first straight line 311 and the second straight line 312 are arranged from one side to the other side in the arrangement orientation D1. By having the first cross line 321 and the second cross line 322 intersect each other at one location, each of the plurality of pairs of cross lines 320 includes a portion L31 in which the first cross line 321 and the second cross line 322 are arranged from one side to the other side in the arrangement orientation D1 and a portion L32 in which the first cross line 321 and the second cross line 322 are arranged from the other side to the one side in the arrangement orientation D1.

The portion L21 is adjacent to both the portion L31 and the portion L32. A magnetic field generated in the portion L31 by current flowing from the first cross line 321 to the second cross line 322 and a magnetic field generated in the portion L32 by current flowing from the first cross line 321 to the second cross line 322 are opposite in direction to each other. Therefore, a noise current induced in the first straight line 311 and the second straight line 312 by a magnetic field acting from the portion L31 on the portion L21 and a noise current induced in the first straight line 311 and the second straight line 312 by a magnetic field acting from the portion L32 on the portion L21 are opposite in direction to each other and cancel each other. On the other hand, a noise current induced in the first cross line 321 and the second cross line 322 by a magnetic field acting from the portion L21 on the portion L31 and a noise current induced in the first cross line 321 and the second cross line 322 by a magnetic field acting from the portion L21 on the portion L32 are opposite in direction to each other and cancel each other. Accordingly, crosstalk that occurs in the wiring member 300 is also suppressed.

An example has been described in which the first straight line 311 and the second straight line 312 do not intersect each other and the first cross line 321 and the second cross line 322 intersect each other at one location. However, “straight” does not mean that the first straight line 311 and the second straight line 312 do not intersect each other; rather, it means that the first straight line 311 connects the first contact 111 and the first other-end contact 211 and the second straight line 312 connects the second contact 112 and the second other-end contact 212. Therefore, the first straight line 311 and the second straight line 312 may intersect each other at an even number of locations when viewed from a direction intersecting the connection plane P1. Likewise, “cross” does not mean that the first cross line 321 and the second cross line 322 intersect each other at one location; rather, it means that the first cross line 321 connects the first contact 111 and the second other-end contact 212 and the second cross line 322 connects the second contact 112 and the first other-end contact 211. Therefore, the first cross line 321 and the second cross line 322 may intersect each other at three or more odd-numbered locations when viewed from a direction intersecting the connection plane P1.

As illustrated in FIG. 1, the wiring member 300 may be a cable 400. The cable 400 includes a plurality of pairs of straight insulated wires 410 respectively constituting the plurality of pairs of straight lines 310, and a plurality of pairs of cross insulated wires 420 respectively constituting the plurality of pairs of cross lines 320. Each of the plurality of pairs of straight insulated wires 410 includes a first straight insulated wire 411 that constitutes the first straight line 311, and a second straight insulated wire 412 that constitutes the second straight line 312. Each of the plurality of pairs of cross insulated wires 420 includes a first cross insulated wire 421 that constitutes the first cross line 321, and a second cross insulated wire 422 that constitutes the second cross line 322.

Each of the first straight insulated wire 411, the second straight insulated wire 412, the first cross insulated wire 421, and the second cross insulated wire 422 includes, for example, a linear signal conductor 431 formed of a metal such as copper, and an insulative sheath 433 covering the signal conductor 431. Each of the first straight insulated wire 411, the second straight insulated wire 412, the first cross insulated wire 421, and the second cross insulated wire 422 may further have an outer conductor 432 that covers the signal conductor 431 via a dielectric layer. The outer conductor 432 is, for example, formed by braiding fine wires of a metal such as copper into a tubular shape. When the signal conductor 431 is covered by the outer conductor 432, the sheath 433 covers the outer conductor 432.

At one end of each of the first straight insulated wire 411, the second straight insulated wire 412, the first cross insulated wire 421, and the second cross insulated wire 422, a portion where the signal conductor 431 is exposed by removal of the outer conductor 432 and the sheath 433 and a portion where the outer conductor 432 is exposed by removal of the sheath 433 are formed in this order. The signal conductor 431 exposed at the one end is electrically connected to the first contact 111 or the second contact 112 by soldering or the like.

At the other end of each of the first straight insulated wire 411, the second straight insulated wire 412, the first cross insulated wire 421, and the second cross insulated wire 422, a portion where the signal conductor 431 is exposed by removal of the outer conductor 432 and the sheath 433 and a portion where the outer conductor 432 is exposed by removal of the sheath 433 are formed in this order. The signal conductor 431 exposed at the other end is electrically connected to the first other-end contact 211 or the second other-end contact 212 by soldering or the like.

By using the cable 400, the wiring member 300 can have improved flexibility, and the connector 100 and the other-end connector 200 can each be connected to a mating component (the mate connector 500 or the other-end mate connector 600) while the wiring member 300 flexibly conforms to surrounding objects. The wiring member 300 may not be formed of a cable. For example, the wiring member 300 may be formed of flexible printed circuits (FPC) or a flexible flat cable (FFC).

Each of the plurality of pairs of straight lines 310 and the plurality of pairs of cross lines 320 may transmit a signal represented by a change in a voltage level. For example, each of the plurality of pairs of mate contacts 510 of the mate connector 500 and the plurality of pairs of other-end mate contacts 610 of the other-end mate connector 600 is electrically connected, on a circuit board, to a conductive signal pattern that transmits a signal represented by a change in a voltage level, and the plurality of pairs of contacts 110 are electrically connected to signal patterns on the circuit board via the plurality of pairs of mate contacts 510, respectively. The plurality of pairs of other-end contacts 210 are electrically connected to signal patterns on the circuit board via the plurality of pairs of other-end mate contacts 610, respectively. As a result, each of the plurality of pairs of straight lines 310 and the plurality of pairs of cross lines 320 transmits a signal represented by a change in a voltage level. By applying the configuration in which the plurality of pairs of straight lines 310 and the plurality of pairs of cross lines 320 are alternately arranged to a signal transmission path, crosstalk can be further suppressed.

Each of the plurality of pairs of straight lines 310 may transmit a differential signal represented by a change in a voltage level of the second straight line 312 relative to the first straight line 311, and each of the plurality of pairs of cross lines 320 may transmit a differential signal represented by a change in a voltage level of the second cross line 322 relative to the first cross line 321. For example, each of the plurality of pairs of mate contacts 510 and the plurality of pairs of other-end mate contacts 610 may be electrically connected, on a circuit board, to a pair of signal patterns that transmit a differential signal. By suppressing common-mode noise, crosstalk can be further suppressed.

As illustrated in FIG. 1, the connector 100 may further include a conductive ground bar 180 that connects the outer conductor 432 of each of the first straight line 311, the second straight line 312, the first cross line 321, and the second cross line 322 to each other. For example, the ground bar 180 extends along the arrangement orientation D1 and is connected to the outer conductor 432 exposed at the above-described one end. For example, the ground bar 180 is formed of a metal plate such as copper.

As illustrated in FIG. 1, the other-end connector 200 may further include a conductive other-end ground bar 280 that connects the outer conductor 432 of each of the first straight line 311, the second straight line 312, the first cross line 321, and the second cross line 322 to each other. For example, the other-end ground bar 280 extends along the arrangement orientation D1 and is connected to the outer conductor 432 exposed at the above-described other end. For example, the other-end ground bar 280 is formed of a metal plate such as copper.

By equalizing the potentials of the outer conductors 432 to each other at both ends of each of the first straight line 311, the second straight line 312, the first cross line 321, and the second cross line 322, crosstalk occurring between the connector 100 and the other-end connector 200 can be further suppressed. The ground bar 180 may be connected to a ground of a mating component (the mate connector 500) of the connector 100, and the other-end ground bar 280 may be connected to a ground of a mating component (the other-end mate connector 600) of the other-end connector 200.

As illustrated in FIG. 1, for example, the connector 100 may further include a plurality of ground contacts 120, and the other-end connector 200 may further include a plurality of other-end ground contacts 220. The mate connector 500 may further include a plurality of mate ground contacts 520, and the other-end mate connector 600 may further include a plurality of other-end mate ground contacts 620. Each of the plurality of mate ground contacts 520 and the plurality of other-end mate ground contacts 620 is formed of, for example, a metal material such as copper and is conductive. Each of the plurality of mate ground contacts 520 and each of the plurality of other-end mate ground contacts 620 are connected to a ground pattern on a circuit board. The ground pattern serves, on the circuit board, as a reference for a voltage level of each signal pattern. The plurality of mate ground contacts 520 are alternately arranged with the plurality of pairs of mate contacts 510 along the arrangement orientation D1. The plurality of other-end mate ground contacts 620 are alternately arranged with the plurality of pairs of other-end mate contacts 610 along the arrangement orientation D1.

The plurality of ground contacts 120 are alternately arranged with the plurality of pairs of contacts 110 along the arrangement orientation D1. Each of the plurality of ground contacts 120 is formed of, for example, a metal material such as copper and is conductive. When the housing 190 mates with the mate housing 590, the plurality of ground contacts 120 respectively contact (are connected to) the plurality of mate ground contacts 520 (the ground of a mating component for the connector 100). The plurality of other-end ground contacts 220 are alternately arranged with the plurality of pairs of other-end contacts 210 along the arrangement orientation D1. Each of the plurality of other-end ground contacts 220 is formed of, for example, a metal material such as copper and is conductive. When the other-end housing 290 mates with the other-end mate housing 690, the plurality of other-end ground contacts 220 respectively contact (are connected to) the other-end mate ground contacts 620 (the ground of a mating component for the other-end connector 200).

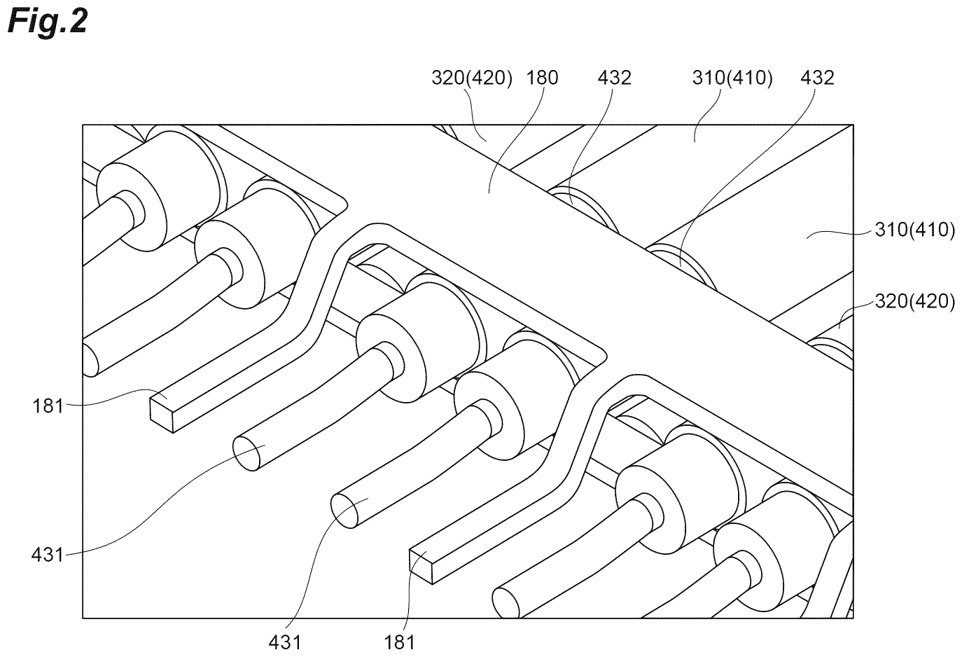

As illustrated in FIG. 2, the connector 100 may further include a plurality of fingers 181. The plurality of fingers 181 are, for example, integrally formed with the ground bar 180 out of a metal plate such as copper and are conductive. The plurality of fingers 181 extend from the ground bar 180, enter between the plurality of pairs of lines including the plurality of pairs of straight lines 310 and the plurality of pairs of cross lines 320, and are respectively connected to the plurality of ground contacts 120. The other-end connector 200 may further include a plurality of other-end fingers 281. The plurality of other-end fingers 281 are, for example, integrally formed with the other-end ground bar 280 out of a metal plate such as copper and are conductive. The plurality of other-end fingers 281 extend from the other-end ground bar 280, enter between the plurality of pairs of lines including the plurality of pairs of straight lines 310 and the plurality of pairs of cross lines 320, and are respectively connected to the plurality of other-end ground contacts 220. By suppressing noise currents in each of the connector 100 and the other-end connector 200, crosstalk can be further suppressed.

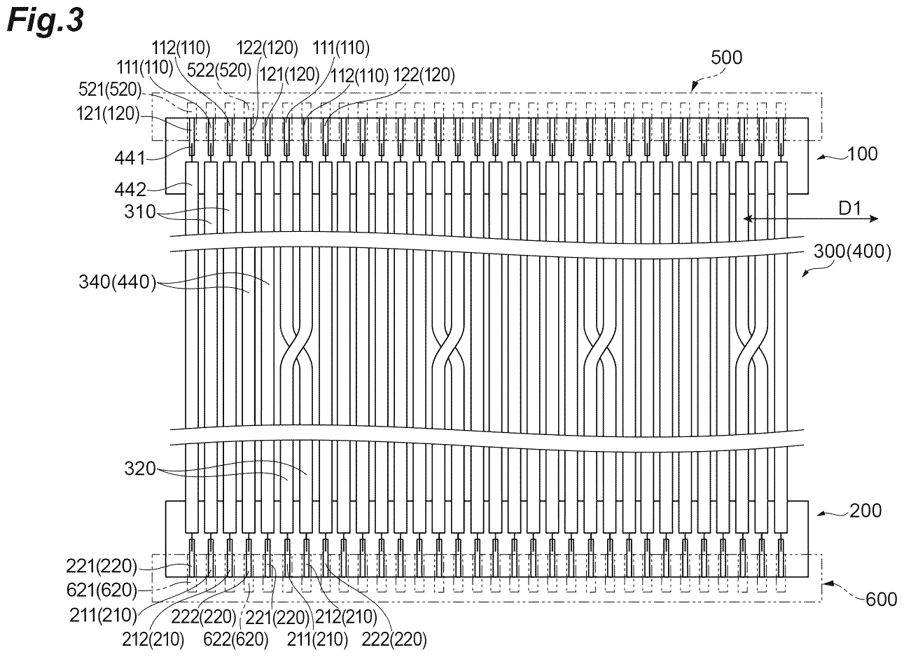

Each of the first straight line 311, the second straight line 312, the first cross line 321, and the second cross line 322 may not have the outer conductor 432. When each of the first straight line 311, the second straight line 312, the first cross line 321, and the second cross line 322 does not have the outer conductor 432, the wiring member 300 may further include, as illustrated in FIG. 3, a plurality of ground lines 340. The plurality of ground lines 340 are alternately arranged, along the arrangement orientation D1, with the plurality of pairs of lines including the plurality of pairs of straight lines 310 and the plurality of pairs of cross lines 320. The plurality of ground lines 340 respectively connect the plurality of ground contacts 120 and the plurality of other-end ground contacts 220. Since the plurality of ground lines 340, whose both ends are connected to ground, are alternately arranged with the plurality of pairs of lines including the plurality of pairs of straight lines 310 and the plurality of pairs of cross lines 320, crosstalk can be further suppressed.

For example, the cable 400 may further include a plurality of ground insulated wires 440 respectively constituting the plurality of ground lines 340. Each of the plurality of ground insulated wires 440 includes, for example, a linear ground conductor 441 formed of a metal such as copper and an insulative sheath 442 covering the ground conductor 441.

The connector 100 may have a plurality of pairs of ground contacts 120, and the other-end connector 200 may have a plurality of pairs of other-end ground contacts 220. The plurality of pairs of ground contacts 120 are arranged along the arrangement orientation D1 so as to respectively correspond to the plurality of pairs of contacts 110. The plurality of pairs of other-end ground contacts 220 are arranged along the arrangement orientation D1 so as to respectively correspond to the plurality of pairs of other-end contacts 210. Each of the plurality of pairs of ground contacts 120 has a first ground contact 121 and a second ground contact 122 arranged from one side to the other side in the arrangement orientation D1, and the first contact 111 and the second contact 112 are located between the first ground contact 121 and the second ground contact 122. Each of the plurality of pairs of other-end ground contacts 220 has a first other-end ground contact 221 and a second other-end ground contact 222 arranged from one side to the other side in the arrangement orientation D1, and the first other-end contact 211 and the second other-end contact 212 are located between the first other-end ground contact 221 and the second other-end ground contact 222.

Corresponding to the plurality of pairs of ground contacts 120, the mate connector 500 may have a plurality of pairs of mate ground contacts 520. Each of the plurality of pairs of mate ground contacts 520 includes a first mate ground contact 521 and a second mate ground contact 522 respectively corresponding to the first ground contact 121 and the second ground contact 122. Also, corresponding to the plurality of pairs of other-end ground contacts 220, the other-end mate connector 600 may have a plurality of pairs of other-end mate ground contacts 620. Each of the plurality of pairs of other-end mate ground contacts 620 includes a first other-end mate ground contact 621 and a second other-end mate ground contact 622 respectively corresponding to the first other-end ground contact 221 and the second other-end ground contact 222.

Corresponding to the plurality of pairs of ground contacts 120 and the plurality of pairs of other-end ground contacts 220, the wiring member 300 may have a plurality of pairs of ground lines 340. The plurality of pairs of ground lines 340 respectively connect the plurality of pairs of ground contacts 120 and the plurality of pairs of other-end ground contacts 220.

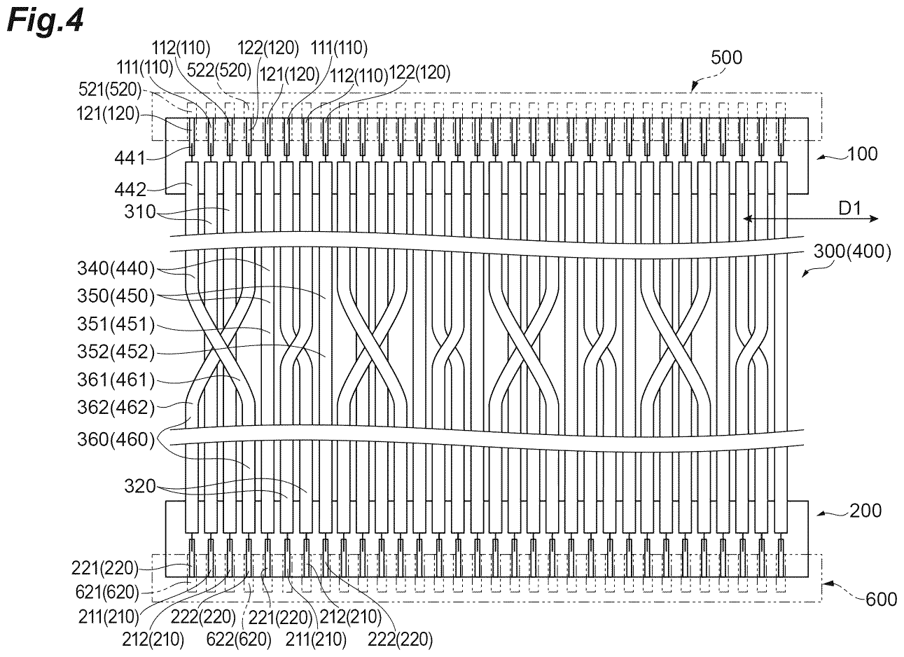

As illustrated in FIG. 4, the plurality of pairs of ground lines 340 may include a plurality of pairs of straight ground lines 350, each pair including a first straight ground line 351 that connects the first ground contact 121 and the first other-end ground contact 221 and a second straight ground line 352 that connects the second ground contact 122 and the second other-end ground contact 222. Further, the plurality of pairs of ground lines 340 may include a plurality of pairs of cross ground lines 360, each pair including a first cross ground line 361 that connects the first ground contact 121 and the second other-end ground contact 222 and a second cross ground line 362 that connects the second ground contact 122 and the first other-end ground contact 221.

For example, the cable 400 may include a plurality of ground insulated wires 440 respectively corresponding to the plurality of pairs of ground lines 340, and the plurality of ground insulated wires 440 may include a plurality of pairs of straight ground insulated wires 450 respectively constituting the plurality of pairs of straight ground lines 350 and a plurality of pairs of cross ground insulated wires 460 respectively constituting the plurality of pairs of cross ground lines 360. Each of the plurality of pairs of straight ground insulated wires 450 includes a first straight ground insulated wire 451 that constitutes the first straight ground line 351 and a second straight ground insulated wire 452 that constitutes the second straight ground line 352. Each of the plurality of pairs of cross ground insulated wires 460 includes a first cross ground insulated wire 461 that constitutes the first cross ground line 361 and a second cross ground insulated wire 462 that constitutes the second cross ground line 362.

The plurality of pairs of straight ground lines 350 and the plurality of pairs of cross ground lines 360 may be alternately arranged along the arrangement orientation D1. By applying to the plurality of ground lines 340 the configuration in which the plurality of pairs of straight ground lines 350 and the plurality of pairs of cross ground lines 360 are alternately arranged, crosstalk that occurs indirectly via the plurality of ground lines 340 can be suppressed.

The plurality of pairs of straight ground lines 350 and the plurality of pairs of cross ground lines 360 may be arranged such that the plurality of pairs of straight ground lines 350 respectively correspond to the plurality of pairs of cross lines 320 and the plurality of pairs of cross ground lines 360 respectively correspond to the plurality of pairs of straight lines 310. Between a pair of lines and a pair of ground lines that are arranged along a direction intersecting the connection plane P1 (for example, an orthogonal direction perpendicular to the arrangement orientation D1), noise current generated in the pair of ground lines by the pair of lines can be suppressed and crosstalk occurring indirectly via the plurality of ground lines 340 can thus be suppressed.

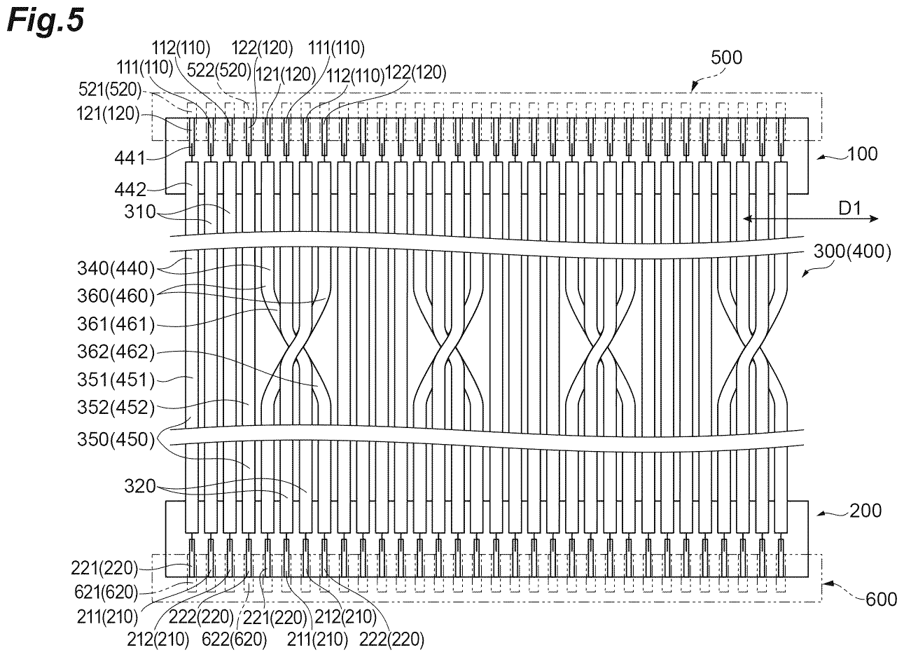

As illustrated in FIG. 5, the plurality of pairs of straight ground lines 350 and the plurality of pairs of cross ground lines 360 may be arranged such that the plurality of pairs of straight ground lines 350 respectively correspond to the plurality of pairs of straight lines 310 and the plurality of pairs of cross ground lines 360 respectively correspond to the plurality of pairs of cross lines 320. Between a pair of lines and a pair of ground lines that are arranged along the arrangement orientation D1, noise current generated in the pair of ground lines by the pair of lines can be suppressed and crosstalk occurring indirectly via the plurality of ground lines 340 can be suppressed.

In FIGS. 4 and 5, examples are illustrated in which the wiring member 300 has both the configuration in which the plurality of pairs of straight lines 310 and the plurality of pairs of cross lines 320 are alternately arranged and the configuration in which the plurality of pairs of straight ground lines 350 and the plurality of pairs of cross ground lines 360 are alternately arranged. However, the wiring member 300 may have the configuration in which the plurality of pairs of straight ground lines 350 and the plurality of pairs of cross ground lines 360 are alternately arranged and may not have the configuration in which the plurality of pairs of straight lines 310 and the plurality of pairs of cross lines 320 are alternately arranged.

In FIG. 4, all of the plurality of pairs of contacts 110 (a plurality of signal contacts) and the plurality of pairs of other-end contacts 210 (a plurality of other-end signal contacts) may be respectively connected by the plurality of pairs of straight lines 310 (a plurality of signal lines) without using the plurality of pairs of cross lines 320. Similarly, in FIG. 5, all of the plurality of pairs of contacts 110 (a plurality of signal contacts) and the plurality of pairs of other-end contacts 210 (a plurality of other-end signal contacts) may be respectively connected by the plurality of pairs of straight lines 310 (a plurality of signal lines) without using the plurality of pairs of cross lines 320. In either case, by applying to the plurality of pairs of ground lines 340 the configuration in which the plurality of pairs of straight ground lines 350 and the plurality of pairs of cross ground lines 360 are alternately arranged, crosstalk that occurs between the plurality of signal lines via the plurality of pairs of ground lines 340 can be suppressed.

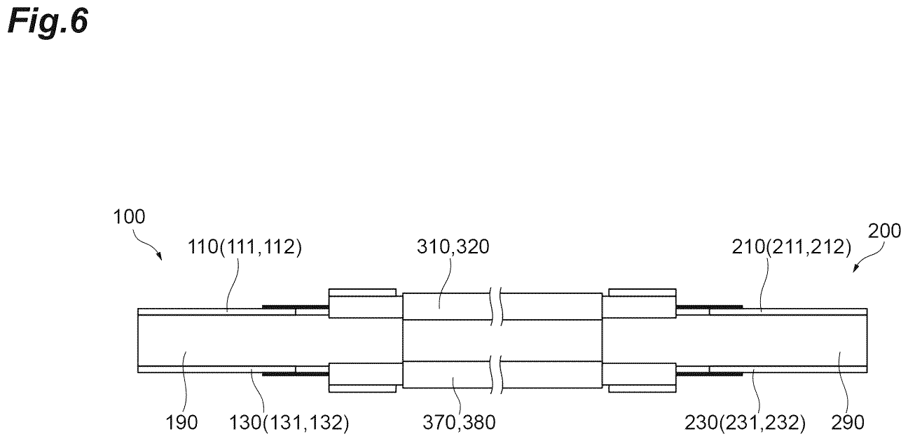

As illustrated in FIG. 6, the connector 100 may further include a second-layer first contact 131 and a second-layer second contact 132 that are arranged along a row parallel to a row in which the first contact 111 and the second contact 112 are arranged so as to respectively correspond to the first contact 111 and the second contact 112. The other-end connector 200 may further include a second-layer first other-end contact 231 and a second-layer second other-end contact 232 that are arranged along a row parallel to a row in which the first other-end contact 211 and the second other-end contact 212 are arranged so as to respectively correspond to the first other-end contact 211 and the second other-end contact 212.

For example, the connector 100 may further include a plurality of pairs of second-layer contacts 130 that are arranged along a row parallel to a row in which the plurality of pairs of contacts 110 are arranged so as to respectively correspond to the plurality of pairs of contacts 110. The plurality of pairs of contacts 110 and the plurality of pairs of second-layer contacts 130 are arranged in a direction intersecting the connection plane P1 (see FIG. 1) (for example, an orthogonal direction perpendicular to the arrangement orientation D1). Each of the plurality of pairs of second-layer contacts 130 may have the second-layer first contact 131 and the second-layer second contact 132 that are arranged so as to respectively correspond to the first contact 111 and the second contact 112. The other-end connector 200 may further include a plurality of pairs of second-layer other-end contacts 230 that are arranged along a row parallel to a row in which the plurality of pairs of other-end contacts 210 are arranged so as to respectively correspond to the plurality of pairs of other-end contacts 210. The plurality of pairs of other-end contacts 210 and the plurality of pairs of second-layer other-end contacts 230 are arranged in a direction intersecting the connection plane P1 (see FIG. 1). Each of the plurality of pairs of second-layer other-end contacts 230 may have the second-layer first other-end contact 231 and the second-layer second other-end contact 232 that are arranged so as to respectively correspond to the first other-end contact 211 and the second other-end contact 212.

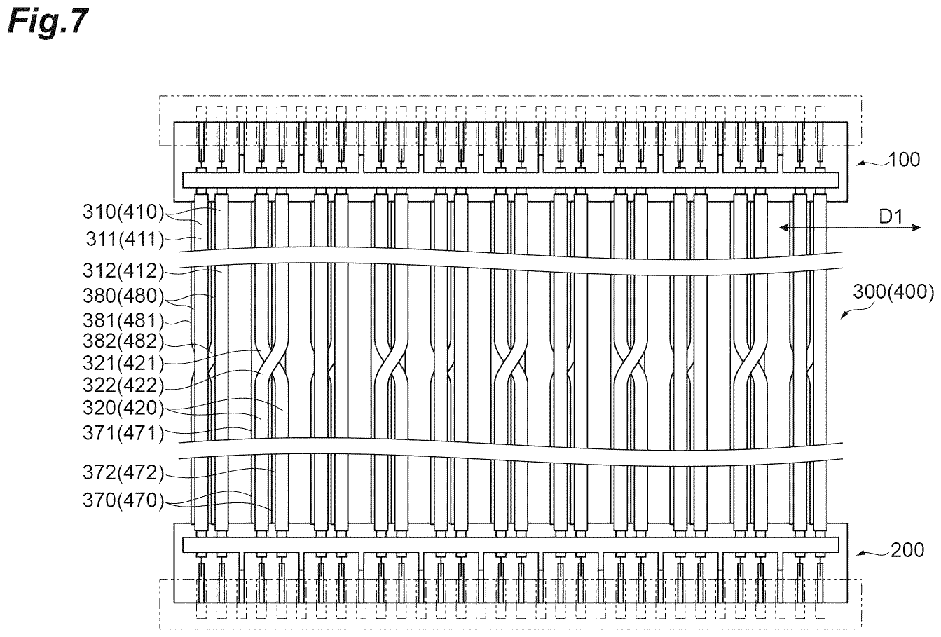

As illustrated in FIG. 7, the wiring member 300 may further include a plurality of pairs of second-layer straight lines 370, each pair including a second-layer first straight line 371 that connects the second-layer first contact 131 and the second-layer first other-end contact 231 and a second-layer second straight line 372 that connects the second-layer second contact 132 and the second-layer second other-end contact 232, and a plurality of pairs of second-layer cross lines 380, each pair including a second-layer first cross line 381 that connects the second-layer first contact 131 and the second-layer second other-end contact 232 and a second-layer second cross line 382 that connects the second-layer second contact 132 and the second-layer first other-end contact 231. For example, the cable 400 may include a plurality of pairs of second-layer straight insulated wires 470 respectively constituting the plurality of pairs of second-layer straight lines 370, and a plurality of pairs of second-layer cross insulated wires 480 respectively constituting the plurality of pairs of second-layer cross lines 380. Each of the plurality of pairs of second-layer straight insulated wires 470 includes a second-layer first straight insulated wire 471 that constitutes the second-layer first straight line 371 and a second-layer second straight insulated wire 472 that constitutes the second-layer second straight line 372. Each of the plurality of pairs of second-layer cross insulated wires 480 includes a second-layer first cross insulated wire 481 that constitutes the second-layer first cross line 381 and a second-layer second cross insulated wire 482 that constitutes the second-layer second cross line 382. The second-layer first straight insulated wire 471, the second-layer second straight insulated wire 472, the second-layer first cross insulated wire 481, and the second-layer second cross insulated wire 482 are configured similarly to the first straight insulated wire 411, the second straight insulated wire 412, the first cross insulated wire 421, and the second cross insulated wire 422.

The plurality of pairs of second-layer straight lines 370 and the plurality of pairs of second-layer cross lines 380 may be alternately arranged along the arrangement orientation D1. The plurality of pairs of second-layer straight lines 370 and the plurality of pairs of second-layer cross lines 380 may be arranged such that the plurality of pairs of second-layer straight lines 370 respectively correspond to the plurality of pairs of cross lines 320 and the plurality of pairs of second-layer cross lines 380 respectively correspond to the plurality of pairs of straight lines 310. In the connector 100, a noise current induced in the second-layer first cross line 381 and the second-layer second cross line 382 by a magnetic field from the first straight line 311 and the second straight line 312 and, in the other-end connector 200, a noise current induced in the second-layer first cross line 381 and the second-layer second cross line 382 by a magnetic field from the first straight line 311 and the second straight line 312 are opposite in direction to each other and cancel each other. Similarly, in the connector 100, a noise current induced in the first straight line 311 and the second straight line 312 by a magnetic field from the second-layer first cross line 381 and the second-layer second cross line 382 and, in the other-end connector 200, a noise current induced in the first straight line 311 and the second straight line 312 by a magnetic field from the second-layer first cross line 381 and the second-layer second cross line 382 are opposite in direction to each other and cancel each other. Further, in the connector 100, a noise current induced in the second-layer first straight line 371 and the second-layer second straight line 372 by a magnetic field from the first cross line 321 and the second cross line 322 and, in the other-end connector 200, a noise current induced in the second-layer first straight line 371 and the second-layer second straight line 372 by a magnetic field from the first cross line 321 and the second cross line 322 are opposite in direction to each other and cancel each other. Similarly, in the connector 100, a noise current induced in the first cross line 321 and the second cross line 322 by a magnetic field from the second-layer first straight line 371 and the second-layer second straight line 372 and, in the other-end connector 200, a noise current induced in the first cross line 321 and the second cross line 322 by a magnetic field from the second-layer first straight line 371 and the second-layer second straight line 372 are opposite in direction to each other and cancel each other. Therefore, crosstalk is suppressed.

### Conclusion

The above disclosure includes the following configurations.
(1) A connector assembly 1 including: a connector 100 having a plurality of pairs of conductive contacts 110 arranged along an arrangement orientation D1; an other-end connector 200 including a plurality of pairs of conductive other-end contacts 210 arranged along the arrangement orientation D1, and a wiring member 300 extending from the connector 100 toward the other-end connector 200 and connecting the plurality of pairs of contacts 110 and the plurality of pairs of other-end contacts 210, respectively, wherein each of the plurality of pairs of contacts 110 includes a first contact 111 and a second contact 112 arranged from one side to another side in the arrangement orientation D1, wherein each of the plurality of pairs of other-end contacts 210 includes a first other-end contact 211 and a second other-end contact 212 arranged from the one side to the other side in the arrangement orientation D1, wherein the wiring member 300 includes: a plurality of pairs of straight lines 310, each pair including a first straight line 311 connecting the first contact 111 and the first other-end contact 211 and a second straight line 312 connecting the second contact 112 and the second other-end contact 212, and a plurality of pairs of cross lines 320 each including a first cross line 321 that connects the first contact 111 and the second other-end contact 212 and a second cross line 322 that connects the second contact 112 and the first other-end contact 211, and wherein the plurality of pairs of straight lines 310 and the plurality of pairs of cross lines 320 are alternately arranged along the arrangement orientation D1. In the connector 100, a noise current induced in the plurality of pairs of cross lines 320 by a magnetic field from the plurality of pairs of straight lines 310 and, in the other-end connector 200, a noise current induced in the plurality of pairs of cross lines 320 by a magnetic field from the plurality of pairs of straight lines 310 are opposite in direction to each other and cancel each other. Similarly, in the connector 100, a noise current induced in the plurality of pairs of straight lines 310 by a magnetic field from the plurality of pairs of cross lines 320 and, in the other-end connector 200, a noise current induced in the plurality of pairs of straight lines 310 by a magnetic field from the plurality of pairs of cross lines 320 are opposite in direction to each other and cancel each other. Therefore, crosstalk is suppressed.
(2) The connector assembly 1 according to (1), wherein the wiring member 300 is a cable 400 including a plurality of pairs of straight insulated wires 410 respectively constituting the plurality of pairs of straight lines 310 and a plurality of pairs of cross insulated wires 420 respectively constituting the plurality of pairs of cross lines 320.
   By using the cable 400, the wiring member 300 can have improved flexibility, and each of the connector 100 and the other-end connector 200 can be connected to a mating component while the wiring member 300 flexibly conforms to surrounding objects.
(3) The connector assembly 1 according to (1), wherein each of the plurality of pairs of straight lines 310 and the plurality of pairs of cross lines 320 transmits a signal represented by a change in a voltage level.
   By applying to a signal transmission path the configuration in which the plurality of pairs of straight lines 310 and the plurality of pairs of cross lines 320 are alternately arranged, crosstalk can be further suppressed.
(4) The connector assembly 1 according to (3), wherein each of the plurality of pairs of straight lines 310 transmits a differential signal represented by a change in a voltage level of the second straight line 312 relative to the first straight line 311, and wherein each of the plurality of pairs of cross lines 320 transmits a differential signal represented by a change in a voltage level of the second cross line 322 relative to the first cross line 321.
   Crosstalk can be further suppressed.
(5) The connector assembly 1 according to (3) or (4), wherein each of the first straight line 311, the second straight line 312, the first cross line 321, and the second cross line 322 includes: a signal conductor 431 that transmits a signal represented by a change in a voltage level; and an outer conductor 432 that covers the signal conductor 431 via a dielectric layer, wherein the connector 100 further includes a conductive ground bar 180 that connects the outer conductor 432 of the first straight line 311, the outer conductor 432 of the second straight line 312, the outer conductor 432 of the first cross line 321, and the outer conductor 432 of the second cross line 322 to each other; and the other-end connector 200 further includes a conductive other-end ground bar 280 that connects the outer conductor 432 of the first straight line 311, the outer conductor 432 of the second straight line 312, the outer conductor 432 of the first cross line 321, and the outer conductor 432 of the second cross line 322 to each other.
   By equalizing, at both ends (one end and the other end) of each of the lines 311, 312, 321, and 322, potentials of the outer conductor 432 to each other, crosstalk occurring between the connector 100 and the other-end connector 200 can be further suppressed.
(6) The connector assembly 1 according to (5), wherein the connector 100 further includes a plurality of conductive ground contacts 120 alternately arranged with the plurality of pairs of contacts 110 along the arrangement orientation D1 and connected to a ground of a mating component for the connector 100, and a plurality of conductive fingers 181 extending from the ground bar 180, entering between the plurality of pairs of lines including the plurality of pairs of straight lines 310 and the plurality of pairs of cross lines 320, and respectively connected to the plurality of ground contacts 120, and wherein the other-end connector 200 further includes: a plurality of conductive other-end ground contacts 220 alternately arranged with the plurality of pairs of other-end contacts 210 along the arrangement orientation D1 and connected to a ground of a mating component for the other-end connector 200; and a plurality of conductive other-end fingers 281 extending from the other-end ground bar 280, entering between the plurality of pairs of lines, and are respectively connected to the plurality of other-end ground contacts 220.

By suppressing noise currents in each of the connector 100 and the other-end connector 200, crosstalk can be further suppressed.
(7) The connector assembly 1 according to (3) or (4), wherein the connector 100 further includes a plurality of conductive ground contacts 120 alternately arranged with the plurality of pairs of contacts 110 along the arrangement orientation D1 and connected to a ground of a mating component for the connector 100, wherein the other-end connector 200 further includes a plurality of conductive other-end ground contacts 220 that are alternately arranged with the plurality of pairs of other-end contacts 210 along the arrangement orientation D1 and connected to a ground of a mating component for the other-end connector 200, and wherein the wiring member 300 further includes a plurality of ground lines 340 respectively connecting the plurality of ground contacts 120 and the plurality of other-end ground contacts 220.
   Since a plurality of ground lines whose both ends are connected to ground are alternately arranged with the plurality of pairs of lines including the plurality of pairs of straight lines 310 and the plurality of pairs of cross lines 320, crosstalk can be further suppressed.
(8) The connector assembly 1 according to (3) or (4), wherein the connector 100 further includes a plurality of pairs of conductive ground contacts 120 arranged along the arrangement orientation D1 so as to respectively correspond to the plurality of pairs of contacts 110 and connected to a ground of a mating component for the connector 100, wherein the other-end connector 200 further includes a plurality of pairs of conductive other-end ground contacts 220 arranged along the arrangement orientation D1 so as to respectively correspond to the plurality of pairs of other-end contacts 210 and connected to a ground of a mating component for the other-end connector 200, wherein each of the plurality of pairs of ground contacts 120 has a first ground contact 121 and a second ground contact 122 arranged from one side to the other side in the arrangement orientation D1 and the first contact 111 and the second contact 112 are located between the first ground contact 121 and the second ground contact 122, wherein each of the plurality of pairs of other-end ground contacts 220 has a first other-end ground contact 221 and a second other-end ground contact 222 arranged from one side to the other side in the arrangement orientation D1 and the first other-end contact 211 and the second other-end contact 212 are located between the first other-end ground contact 221 and the second other-end ground contact 222, wherein the wiring member 300 further includes: a plurality of pairs of straight ground lines 350 each including a first straight ground line 351 connecting the first ground contact 121 and the first other-end ground contact 221 and a second straight ground line 352 connecting the second ground contact 122 and the second other-end ground contact 222 and a plurality of pairs of cross ground lines 360 each including a first cross ground line 361 connecting the first ground contact 121 and the second other-end ground contact 222 and a second cross ground line 362 connecting the second ground contact 122 and the first other-end ground contact 221, and wherein the plurality of pairs of straight ground lines 350 and the plurality of pairs of cross ground lines 360 are alternately arranged along the arrangement orientation D1.
   By applying to the plurality of ground lines 340 the configuration in which the plurality of pairs of straight ground lines 350 and the plurality of pairs of cross ground lines 360 are alternately arranged, crosstalk that occurs indirectly via the plurality of pairs of ground lines 340 can be suppressed.
(9) The connector assembly 1 according to (8), wherein the plurality of pairs of straight ground lines 350 and the plurality of pairs of cross ground lines 360 are arranged such that the plurality of pairs of straight ground lines 350 respectively correspond to the plurality of pairs of straight lines 310 and the plurality of pairs of cross ground lines 360 respectively correspond to the plurality of pairs of cross lines 320. Between a pair of lines and a pair of ground lines 340 that are arranged along an orthogonal direction perpendicular to the arrangement orientation D1, noise current generated in the pair of ground lines 340 by the pair of lines can be suppressed and crosstalk occurring indirectly via the plurality of pairs of ground lines 340 can be suppressed.
(10) The connector assembly 1 according to (8), wherein the plurality of pairs of straight ground lines 350 and the plurality of pairs of cross ground lines 360 are arranged such that the plurality of pairs of straight ground lines 350 respectively correspond to the plurality of pairs of cross lines 320 and the plurality of pairs of cross ground lines 360 respectively correspond to the plurality of pairs of straight lines 310. Between a pair of lines and a pair of ground lines 340 that are arranged along the arrangement orientation D1, noise current generated in the pair of ground lines 340 by the pair of lines can be suppressed and crosstalk occurring indirectly via the plurality of pairs of ground lines 340 can be suppressed.
(11) The connector assembly 1 according to (1), wherein the plurality of pairs of contacts 110 are a plurality of pairs of ground contacts 120 connected to a ground of a mating component for the connector 100, the plurality of pairs of other-end contacts 210 are a plurality of pairs of other-end ground contacts 220 connected to a ground of a mating component for the other-end connector 200, the connector 100 further includes a plurality of signal contacts respectively corresponding to the plurality of pairs of contacts 110 and each of the plurality of signal contacts is located between the first contact 111 and the second contact 112, the other-end connector 200 further includes a plurality of other-end signal contacts respectively corresponding to the plurality of pairs of other-end contacts 210 and each of the plurality of other-end signal contacts is located between the first other-end contact 211 and the second other-end contact 212, and the wiring member 300 further includes a plurality of signal lines respectively connecting the plurality of signal contacts and the plurality of other-end signal contacts. By applying to the plurality of pairs of ground lines 340, which respectively connect the plurality of pairs of ground contacts 120 and the plurality of pairs of other-end ground contacts 220, the configuration in which the plurality of pairs of straight ground lines 350 and the plurality of pairs of cross ground lines 360 are alternately arranged, crosstalk that occurs between the plurality of signal lines via the plurality of pairs of ground lines can be suppressed.
(12) A connector assembly 1 including: a connector 100 including: a conductive first contact 111 and a conductive second contact 112 arranged from one side to the other side in an arrangement orientation D1; and a conductive second-layer first contact 131 and a conductive second-layer second contact 132 arranged along a row parallel to a row in which the first contact 111 and the second contact 112 are arranged, so as to respectively correspond to the first contact 111 and the second contact 112; an other-end connector 200 including: a conductive first other-end contact 211 and a conductive second other-end contact 212 arranged from the one side to the other side in the arrangement orientation D1; and a conductive second-layer first other-end contact 231 and a conductive second-layer second other-end contact 232 arranged along a row parallel to a row in which the first other-end contact 211 and the second other-end contact 212 are arranged so as to respectively correspond to the first other-end contact 211 and the second other-end contact 212; and a wiring member 300 including: a first straight line 311 extending from the connector 100 to the other-end connector 200 and connecting the first contact 111 and the first other-end contact 211; a second straight line 312 extending from the connector 100 to the other-end connector 200 and connecting the second contact 112 and the second other-end contact 212; a second-layer first cross line 381 extending from the connector 100 to the other-end connector 200 and connecting the second-layer first contact 131 and the second-layer second other-end contact 232; and a second-layer second cross line 382 extending from the connector 100 to the other-end connector 200 and connecting the second-layer second contact 132 and the second-layer first other-end contact 231.
   In the connector 100, a noise current induced in the second-layer first cross line 381 and the second-layer second cross line 382 by a magnetic field from the first straight line 311 and the second straight line 312 and, in the other-end connector 200, a noise current induced in the second-layer first cross line 381 and the second-layer second cross line 382 by a magnetic field from the first straight line 311 and the second straight line 312 are opposite in direction to each other and cancel each other. Similarly, in the connector 100, a noise current induced in the first straight line 311 and the second straight line 312 by a magnetic field from the second-layer first cross line 381 and the second-layer second cross line 382 and, in the other-end connector 200, a noise current induced in the first straight line 311 and the second straight line 312 by a magnetic field from the second-layer first cross line 381 and the second-layer second cross line 382 are opposite in direction to each other and cancel each other. Therefore, crosstalk is suppressed.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A connector assembly comprising:
a connector comprising a plurality of pairs of conductive contacts arranged along an arrangement orientation;
an other-end connector comprising a plurality of pairs of conductive other-end contacts arranged along the arrangement orientation; and
a wiring member extending from the connector toward the other-end connector and connecting the plurality of pairs of contacts and the plurality of pairs of other-end contacts, respectively,
wherein each of the plurality of pairs of contacts comprises a first contact and a second contact arranged from one side to another side in the arrangement orientation,
wherein each of the plurality of pairs of other-end contacts comprises a first other-end contact and a second other-end contact arranged from the one side to the other side in the arrangement orientation,
wherein the wiring member comprises:
a plurality of pairs of straight lines, each pair comprising a first straight line connecting the first contact and the first other-end contact, and a second straight line connecting the second contact and the second other-end contact; and
a plurality of pairs of cross lines, each pair comprising a first cross line connecting the first contact and the second other-end contact, and a second cross line connecting the second contact and the first other-end contact, and
wherein the plurality of pairs of straight lines and the plurality of pairs of cross lines are alternately arranged along the arrangement orientation.

2. The connector assembly according to claim 1, wherein the wiring member is a cable comprising a plurality of pairs of straight insulated wires respectively forming the plurality of pairs of straight lines, and a plurality of pairs of cross insulated wires respectively forming the plurality of pairs of cross lines.

3. The connector assembly according to claim 1, wherein each of the plurality of pairs of straight lines and the plurality of pairs of cross lines is configured to transmit a signal represented by a change in a voltage level.

4. The connector assembly according to claim 3, wherein each of the plurality of pairs of straight lines is configured to transmit a differential signal represented by the change in the voltage level of the second straight line relative to the first straight line, and
wherein each of the plurality of pairs of cross lines is configured to transmit a differential signal represented by the change in the voltage level of the second cross line relative to the first cross line.

5. The connector assembly according to claim 3, wherein each of the first straight line, the second straight line, the first cross line, and the second cross line comprises:
a signal conductor that transmits a signal represented by the change in the voltage level; and
an outer conductor that covers the signal conductor via a dielectric layer,
wherein the connector further comprises a conductive ground bar that extends along the arrangement orientation and connects the outer conductor of the first straight line, the outer conductor of the second straight line, the outer conductor of the first cross line, and the outer conductor of the second cross line to each other, and
wherein the other-end connector further comprises a conductive other-end ground bar that extends along the arrangement orientation and connects the outer conductor of the first straight line, the outer conductor of the second straight line, the outer conductor of the first cross line, and the outer conductor of the second cross line to each other.

6. The connector assembly according to claim 5, wherein the connector further comprises:
a plurality of conductive ground contacts alternately arranged with the plurality of pairs of contacts along the arrangement orientation and connected to a ground of a mating component for the connector; and
a plurality of conductive fingers extending from the ground bar, entering between the plurality of pairs of lines comprising the plurality of pairs of straight lines and the plurality of pairs of cross lines, and respectively connected to the plurality of ground contacts, and
wherein the other-end connector further comprises:
a plurality of conductive other-end ground contacts alternately arranged with the plurality of pairs of other-end contacts along the arrangement orientation and connected to a ground of a mating component for the other-end connector; and
a plurality of conductive other-end fingers extending from the other-end ground bar, entering between the plurality of pairs of lines, and respectively connected to the plurality of other-end ground contacts.

7. The connector assembly according to claim 3, wherein the connector further comprises a plurality of conductive ground contacts alternately arranged with the plurality of pairs of contacts along the arrangement orientation and connected to a ground of a mating component for the connector,
wherein the other-end connector further comprises a plurality of conductive other-end ground contacts alternately arranged with the plurality of pairs of other-end contacts along the arrangement orientation and connected to a ground of a mating component for the other-end connector, and
wherein the wiring member further comprises a plurality of ground lines respectively connecting the plurality of ground contacts and the plurality of other-end ground contacts.

8. The connector assembly according to claim 3, wherein the connector further comprises a plurality of pairs of conductive ground contacts arranged along the arrangement orientation so as to respectively correspond to the plurality of pairs of contacts, and connected to a ground of a mating component for the connector,
wherein the other-end connector further comprises a plurality of pairs of conductive other-end ground contacts arranged along the arrangement orientation so as to respectively correspond to the plurality of pairs of other-end contacts, and connected to a ground of a mating component for the other-end connector,
wherein each of the plurality of pairs of ground contacts has a first ground contact and a second ground contact arranged from the one side to the other side in the arrangement orientation, and the first contact and the second contact are located between the first ground contact and the second ground contact,
wherein each of the plurality of pairs of other-end ground contacts has a first other-end ground contact and a second other-end ground contact arranged from the one side to the other side in the arrangement orientation, and the first other-end contact and the second other-end contact are located between the first other-end ground contact and the second other-end ground contact,
wherein the wiring member further comprises:
a plurality of pairs of straight ground lines, each pair comprising a first straight ground line connecting the first ground contact and the first other-end ground contact, and a second straight ground line connecting the second ground contact and the second other-end ground contact; and
a plurality of pairs of cross ground lines, each pair comprising a first cross ground line connecting the first ground contact and the second other-end ground contact, and a second cross ground line connecting the second ground contact and the first other-end ground contact, and
wherein the plurality of pairs of straight ground lines and the plurality of pairs of cross ground lines are alternately arranged along the arrangement orientation.

9. The connector assembly according to claim 8, wherein the plurality of pairs of straight ground lines and the plurality of pairs of cross ground lines are arranged such that the plurality of pairs of straight ground lines respectively correspond to the plurality of pairs of straight lines and the plurality of pairs of cross ground lines respectively correspond to the plurality of pairs of cross lines.

10. The connector assembly according to claim 8, wherein the plurality of pairs of straight ground lines and the plurality of pairs of cross ground lines are arranged such that the plurality of pairs of straight ground lines respectively correspond to the plurality of pairs of cross lines and the plurality of pairs of cross ground lines respectively correspond to the plurality of pairs of straight lines.

11. The connector assembly according to claim 1, wherein the plurality of pairs of contacts are connected to a ground of a mating component for the connector,
the plurality of pairs of other-end contacts are connected to a ground of a mating component for the other-end connector,
the connector further comprises a plurality of signal contacts respectively corresponding to the plurality of pairs of contacts, and each of the plurality of signal contacts is located between the first contact and the second contact,
the other-end connector further comprises a plurality of other-end signal contacts respectively corresponding to the plurality of pairs of other-end contacts, and each of the plurality of other-end signal contacts is located between the first other-end contact and the second other-end contact, and
the wiring member further comprises a plurality of signal lines respectively connecting the plurality of signal contacts and the plurality of other-end signal contacts.

12. A connector assembly comprising:
a connector comprising a plurality of pairs of conductive contacts arranged along an arrangement orientation;
an other-end connector comprising a plurality of pairs of conductive other-end contacts arranged along the arrangement orientation; and
a wiring member extending from the connector toward the other-end connector and connecting the plurality of pairs of contacts and the plurality of pairs of other-end contacts, respectively,
wherein each of the plurality of pairs of contacts comprises a first contact and a second contact arranged from one side to another side in the arrangement orientation,
wherein each of the plurality of pairs of other-end contacts comprises a first other-end contact and a second other-end contact arranged from the one side to the other side in the arrangement orientation,
wherein the wiring member comprises:
a plurality of pairs of straight lines, each pair comprising a first straight line connecting the first contact and the first other-end contact, and a second straight line connecting the second contact and the second other-end contact; and
a plurality of pairs of cross lines, each pair comprising a first cross line connecting the first contact and the second other-end contact, and a second cross line connecting the second contact and the first other-end contact,
wherein the plurality of pairs of straight lines and the plurality of pairs of cross lines are alternately arranged along the arrangement orientation,
wherein the wiring member further comprises:
a plurality of pairs of straight ground lines, each pair comprising a first straight ground line and a second straight ground line connected to the connector so as to be connected to a ground and connected to the other-end connector so as to be connected to an other-end ground, wherein the first straight ground line and the second straight ground line are arranged from the one side to the other side in the arrangement orientation at the connector and are arranged from the one side to the other side in the arrangement orientation at the other-end connector; and
a plurality of pairs of cross ground lines, each pair comprising a first cross ground line and a second cross ground line connected to the connector so as to be connected to the ground and connected to the other-end connector so as to be connected to the other-end ground, wherein the first cross ground line and the second cross ground line are arranged from the one side to the other side in the arrangement orientation at the connector and are arranged from the other side to the one side in the arrangement orientation at the other-end connector, and
wherein the plurality of pairs of straight ground lines and the plurality of pairs of cross ground lines are alternately arranged along the arrangement orientation.

13. The connector assembly according to claim 12, wherein the plurality of pairs of straight ground lines and the plurality of pairs of cross ground lines are arranged such that the plurality of pairs of straight ground lines respectively correspond to the plurality of pairs of straight lines and the plurality of pairs of cross ground lines respectively correspond to the plurality of pairs of cross lines.

14. The connector assembly according to claim 13, wherein each of the first straight line, the second straight line, the first cross line, and the second cross line comprises a signal conductor and an outer conductor covering the signal conductor via a dielectric layer,
wherein the first straight ground line is the outer conductor of the first straight line,
wherein the second straight ground line is the outer conductor of the second straight line,
wherein the first cross ground line is the outer conductor of the first cross line, and
wherein the second cross ground line is the outer conductor of the second cross line.

15. The connector assembly according to claim 14, wherein the connector further comprises:
a conductive ground bar connecting the outer conductor of the first straight line, the outer conductor of the second straight line, the outer conductor of the first cross line, and the outer conductor of the second cross line to each other;
a plurality of conductive ground contacts alternately arranged with the plurality of pairs of contacts along the arrangement orientation and connected to the ground; and
a plurality of conductive fingers extending from the ground bar, entering between the plurality of pairs of lines comprising the plurality of pairs of straight lines and the plurality of pairs of cross lines, and respectively connected to the plurality of ground contacts, and
wherein the other-end connector further comprises:
a conductive other-end ground bar connecting the outer conductor of the first straight line, the outer conductor of the second straight line, the outer conductor of the first cross line, and the outer conductor of the second cross line to each other;
a plurality of conductive other-end ground contacts alternately arranged with the plurality of pairs of other-end contacts along the arrangement orientation and connected to the other-end ground; and
a plurality of conductive other-end fingers extending from the other-end ground bar, entering between the plurality of pairs of lines, and respectively connected to the plurality of other-end ground contacts.

16. The connector assembly according to claim 12, wherein the plurality of pairs of straight ground lines and the plurality of pairs of cross ground lines are arranged such that the plurality of pairs of straight ground lines respectively correspond to the plurality of pairs of cross lines and the plurality of pairs of cross ground lines respectively correspond to the plurality of pairs of straight lines.

17. The connector assembly according to claim 16, wherein the connector further comprises a plurality of pairs of conductive ground contacts arranged along the arrangement orientation so as to respectively correspond to the plurality of pairs of contacts,
wherein the other-end connector further comprises a plurality of pairs of conductive other-end ground contacts arranged along the arrangement orientation so as to respectively correspond to the plurality of pairs of other-end contacts,
wherein each of the plurality of pairs of ground contacts has a first ground contact and a second ground contact arranged from the one side to the other side in the arrangement orientation, and the first contact and the second contact are located between the first ground contact and the second ground contact,
wherein each of the plurality of pairs of other-end ground contacts has a first other-end ground contact and a second other-end ground contact arranged from the one side to the other side in the arrangement orientation, and the first other-end contact and the second other-end contact are located between the first other-end ground contact and the second other-end ground contact,
wherein the first straight ground line connects the first ground contact and the first other-end ground contact,
wherein the second straight ground line connects the second ground contact and the second other-end ground contact,
wherein the first cross ground line connects the first ground contact and the second other-end ground contact, and
wherein the second cross ground line connects the second ground contact and the first other-end ground contact.

18. A connector assembly comprising:
a connector comprising:
a conductive first contact and a conductive second contact arranged from one side to another side in an arrangement orientation; and
a conductive second-layer first contact and a conductive second-layer second contact arranged along a row parallel to a row in which the first contact and the second contact are arranged, so as to respectively correspond to the first contact and the second contact;
an other-end connector comprising:
a conductive first other-end contact and a conductive second other-end contact arranged from the one side to the other side in the arrangement orientation; and
a conductive second-layer first other-end contact and a conductive second-layer second other-end contact arranged along a row parallel to a row in which the first other-end contact and the second other-end contact are arranged, so as to respectively correspond to the first other-end contact and the second other-end contact; and
a wiring member comprising:
a first straight line extending from the connector to the other-end connector and connecting the first contact and the first other-end contact;
a second straight line extending from the connector to the other-end connector and connecting the second contact and the second other-end contact;
a second-layer first cross line extending from the connector to the other-end connector and connecting the second-layer first contact and the second-layer second other-end contact; and
a second-layer second cross line extending from the connector to the other-end connector and connecting the second-layer second contact and the second-layer first other-end contact.

19. The connector assembly according to claim 18, wherein the wiring member further comprises:
a pair of straight ground lines comprising a first straight ground line and a second straight ground line connected to the connector so as to be connected to a ground and connected to the other-end connector so as to be connected to an other-end ground, wherein the first straight ground line and the second straight ground line are arranged from the one side to the other side in the arrangement orientation at the connector and are arranged from the one side to the other side in the arrangement orientation at the other-end connector; and
a pair of cross ground lines comprising a first cross ground line and a second cross ground line connected to the connector so as to be connected to the ground and connected to the other-end connector so as to be connected to the other-end ground, wherein the first cross ground line and the second cross ground line are arranged from the one side to the other side in the arrangement orientation at the connector and are arranged from the other side to the one side in the arrangement orientation at the other-end connector,
wherein the pair of straight ground lines corresponds to the first straight line and the second straight line, and
wherein the pair of cross ground lines corresponds to the second-layer first cross line and the second-layer second cross line.

20. The connector assembly according to claim 18, wherein the wiring member further comprises:
a pair of straight ground lines comprising a first straight ground line and a second straight ground line connected to the connector so as to be connected to a ground and connected to the other-end connector so as to be connected to an other-end ground, wherein the first straight ground line and the second straight ground line are arranged from the one side to the other side in the arrangement orientation at the connector and are arranged from the one side to the other side in the arrangement orientation at the other-end connector; and
a pair of cross ground lines comprising a first cross ground line and a second cross ground line connected to the connector so as to be connected to the ground and connected to the other-end connector so as to be connected to the other-end ground, wherein the first cross ground line and the second cross ground line are arranged from the one side to the other side in the arrangement orientation at the connector and are arranged from the other side to the one side in the arrangement orientation at the other-end connector,
wherein the pair of straight ground lines corresponds to the second-layer first cross line and the second-layer second cross line, and
wherein the pair of cross ground lines corresponds to the first straight line and the second straight line.
